(19) United States
(12) Patent Application Publication
(10) Pub. No.: US 2026/0254406 A1
(43) Pub. Date: Aug. 27, 2026

(54) FLEXIBLE SOLAR PANEL BATTERY RECHARGING SYSTEM FOR ELECTRIFIED VEHICLES

(71) Applicant: TOFIK RASULOV, WINNETKA, CA (US)

(72) Inventor: TOFIK RASULOV, WINNETKA, CA (US)

(21) Appl. No.: 19/653,098

(22) Filed: Apr. 20, 2026

Related U.S. Application Data
(63) Continuation-in-part of application No. 19/260,566, filed on Jul. 6, 2025, now Pat. No. 12,606,048.
(60) Provisional application No. 63/684,414, filed on Aug. 18, 2024.

(51) Int. Cl. H02S 30/20; B60J 11/04; B60L 53/51; H02J 7/35; H02S 20/30

(52) U.S. Cl. CPC H02S 30/20; B60L 53/51; H02J 7/35; H02S 20/30; B60J 11/04

(57) ABSTRACT

The embodiments disclose a battery charging system having a flexible solar panel recharging system configured to deploy a flexible solar panel over an exterior roof surface while the vehicle is parked, the system includes a rear underbody deployment assembly having a motor driven winding drum for storing and releasing the flexible solar panel and a front underbody deployment assembly having two motor driven pulleys coupled to deployment wires embedded along opposing side edges of the flexible solar panel, the flexible solar panel is pulled from the rear underbody deployment assembly toward a front portion of the vehicle along guides and rails disposed along opposing sides of the vehicle body, the guides and rails elevate the flexible solar panel above the roof surface during deployment to prevent contact with the vehicle roof, electrical energy generated by the flexible solar panel is transmitted to recharge at least one vehicle battery.

### CROSS-REFERENCE TO RELATED APPLICATIONS

This Patent Application is a Continuation-in-part and claims priority to United States Patent Application entitled: “SWAPPABLE BATTERY FOR ELECTRIFIED VEHICLE AND METHOD OF CONSTRUCTION”, U.S. Ser. No. 19/260,5126 filed on Jul. 6, 2025 by Tofik Rasulov, which claims benefit of U.S. Provisional Application, U.S. Ser. No. 63/6808,414 filed on Aug. 18, 2024 by Tofik Rasulov, which all of the above are incorporated herein by reference.

### BACKGROUND

Electrified vehicles (EVs) are being adopted at an increasing rate; however, their widespread use is limited by factors such as restricted driving range and limited availability of fast-charging infrastructure. Even when fast-charging stations are available, charging typically requires approximately 30 minutes, which may result in congestion as the number of EVs continues to grow. In addition, charging infrastructure is often sparse between major cities, further limiting practical EV operation.

### FIELD OF THE INVENTION

The present invention relates to electrical power supply systems for electrified vehicles and, more particularly, to systems for recharging vehicle batteries using solar energy.

### SUMMARY OF THE INVENTION

During periods in which an electrified vehicle is parked, the vehicle typically consumes only a small amount of electrical energy, primarily to supply power to onboard computer systems, sensors, and electronic devices. The present invention provides a flexible solar panel battery recharging system configured to utilize these parked periods by generating electrical energy from sunlight and recharging one or more vehicle batteries without requiring connection to an external charging station.

In one embodiment, the system includes at least one flexible solar panel that is automatically deployable over an exterior surface of the electrified vehicle when the vehicle is in a parked condition. The flexible solar panel may be formed as a single continuous panel or as a plurality of interconnected flexible panel sections. When exposed to sunlight, the flexible solar panel generates electrical energy that is transmitted to vehicle power systems for battery recharging.

The flexible solar panel is stored in a retracted configuration when not in use and is wound onto a rear-mounted winding mechanism positioned at the underside of the vehicle. The flexible solar panel is deployed from the rear of the vehicle toward the front portion of the vehicle using two cable wires coupled to opposing side edges of the flexible solar panel.

The deployment cables are routed along the left and right sides of the vehicle under guide structures that extend along the vehicle body from the rear portion of the vehicle, over the rear fenders, a roof portion, and the front fenders. The guide structures define controlled pathways for deployment and retraction of the flexible solar panel and constrain the movement of the flexible solar panel to a predetermined direction during operation.

Rails elevate the flexible solar panel to secure the flexible solar panel under the guide structures. The rails elevate the flexible solar panel above the exterior surface of the vehicle roof during deployment, thereby reducing friction, preventing direct contact with the vehicle roof surface, and minimizing the risk of mechanical damage to both the flexible solar panel and the vehicle roof.

A front-mounted winding mechanism is configured to pull the deployment cables forward during a deployment operation. In one embodiment, the front-mounted winding mechanism includes a motor-driven pulley system that winds the deployment cables to draw the flexible solar panel from the rear-mounted winding mechanism toward the front of the vehicle. Retraction of the flexible solar panel is performed by reversing the operation of the winding mechanism in the rear.

During deployment, the flexible solar panel travels along the guided path defined by the guide structures and remains aligned by the rails. The guide structures restrict the lateral movement of the flexible solar panel and ensure controlled movement relative to the vehicle roof.

When fully deployed, the flexible solar panel covers substantially the entire upper exterior surface of the vehicle and is exposed to sunlight. In this deployed state, the flexible solar panel generates electrical energy that supplements the charging of the vehicle battery system during extended parking periods.

Electrical energy generated by the flexible solar panel is transmitted through a recharging circuit to a power relay, which directs the electrical energy to an auxiliary battery and to a vehicle charging port system configured to supply electrical power to one or more vehicle batteries. The control board regulates the charging of vehicle batteries based on operating conditions, battery state of charge, and available solar-generated power.

Charging status information associated with the flexible solar panel recharging system may be transmitted to a user device. In one embodiment, the user device executes a recharging application configured to display information such as a battery charge level, a recharging rate, and an estimated driving range based on current battery conditions.

The flexible solar panel recharging system may be activated automatically when the vehicle enters a parked condition or manually by a user command. The system enables solar-based recharging of vehicle batteries while the vehicle remains parked, thereby reducing reliance on external charging infrastructure and increasing overall energy efficiency of the electrified vehicle.

### BRIEF DESCRIPTION OF THE DRAWINGS

FIG. 1 shows an illustration of one example of a flexible solar panel recharging system in a deployed configuration.

FIG. 2 shows a block diagram flowchart of an example of a flexible solar panel recharging system of one embodiment.

FIG. 3 shows a block diagram of an exploded view inside the pulling mechanism box under the front part of an EV of one embodiment.

FIG. 4 shows, for illustrative purposes only, an exploded view inside of the rear box under the rear body part of an EV of one embodiment.

FIG. 5A shows an illustration of a rear view of an EV of one embodiment.

FIG. 5B shows an illustration of a left side of the guide, rail, solar panel, and roof of an EV of one embodiment.

FIG. 5C shows an illustration of a right side of the guide, rail, solar panel, and roof of an EV of one embodiment.

FIG. 6A shows an illustration of the top view of a flexible solar panel of one embodiment.

FIG. 6B shows an illustration of a detail, left side view of a flexible solar panel, guide, rail, flexible solar panel, and an EV's roof of one embodiment.

FIG. 6C shows an illustration of the view of the top part of FIG. 5A with the left and right parts for a flexible solar panel of one embodiment.

FIG. 6D shows an illustration of a flexible solar panel in a rolled position of one embodiment.

FIG. 6E shows an illustration of a more detailed view of section A of FIG. 5A of one embodiment.

FIG. 7 shows an illustration of a solar panel drum charging circuit connections of one embodiment.

FIG. 8 shows an illustration of a user-parked EV with a deployed flexible solar panel to recharge the batteries while parked of one embodiment.

### DETAILED DESCRIPTION OF THE INVENTION

In the following description, reference is made to the accompanying drawings, which form a part hereof, and which are shown by way of illustration a specific example in which the invention may be practiced. It is to be understood that other embodiments may be utilized and structural changes may be made without departing from the scope of the present invention.

n this disclosure description, the flexible panel is deployed from the rear, however, it should be understood that deployment and retraction may also be configured to occur be deployed from rear to front and retracted in the reverse.

The terms used herein, including “EV,” “electrified vehicle,” “electric vehicle,” and similar vehicle-identifying terminology, may be used interchangeably without any change in meaning unless expressly stated otherwise. As used herein, such terms generally refer to a vehicle utilizing electrical energy for propulsion, storage, or onboard power functions, and may include battery electric vehicles, hybrid electric vehicles, plug-in hybrid vehicles, solar-assisted vehicles, low-speed electric vehicles, utility vehicles, passenger vehicles, commercial vehicles, autonomous vehicles, and other roadworthy or off-road vehicles incorporating one or more electrically powered systems. Use of one term in place of another is for convenience of description and is not intended to limit the scope of the disclosed embodiments to any particular vehicle type, propulsion architecture, size, manufacturer, or operational class.

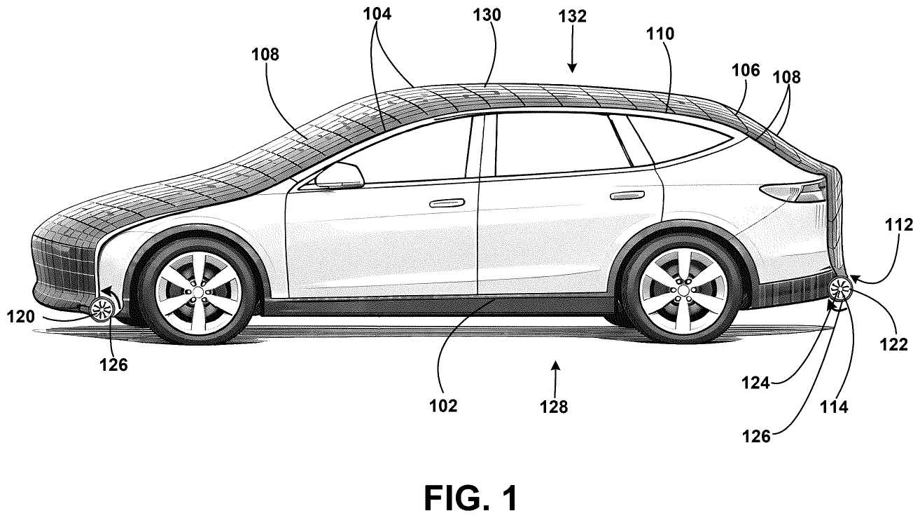

FIG. 1 shows an illustration of a flexible solar panel recharging system 100 of one embodiment. FIG. 1 shows an electrified vehicle (“EV”) 102 with a guide 104 covering the part of the flexible solar panel 106 and rail 108 elevating the flexible solar panel 106 over the roof 110 of EV 102. FIG. 1 also shows the rear edge 112 of the flexible solar panel 106 winding on a drum 104. At a front end 116 of the EV 102 is a cable wire 118 for pulling the flexible solar panel 106 and winding it on a front pulley 120 or back pulley 122.

FIG. 1 shows a certain embodiment that includes the system 100 with a front pulley 120 and a rear drum 124. The rear drum 124 is positioned at the rear underside of the electrified vehicle 106 and is configured to store the flexible solar panel 106 in a wound configuration when the system 100 is not in use. The system also includes left solar panel deployment cable wires 126 for a left side 128 of the EV 102 and solar right panel deployment cable wires 130 for a right-side 132 of the EV 102. The wires 126 and 130 are coupled to opposing side edges of the flexible solar panel 106. The cable wires 126 and 130 are configured to deploy the flexible solar panel 106 from the rear drum 124 toward the front of the EV 102, or to retract the flexible solar panel 106 from the front toward the rear of the EV 102 for storage.

FIG. 1 illustrates one non-limiting example in which the flexible solar panel 106 is deployed over substantially the entire upper exterior portion of the EV 102. In other embodiments, the flexible solar panel 106 may be deployed over only a selected portion of the EV 102, including only a rear portion, only a roof portion, only a front portion, or any combination of the hood, windshield area, roof, rear hatch, trunk, or other upper exterior surfaces. Accordingly, the embodiment of FIG. 1 should not be understood as requiring full-length or full-surface coverage in all embodiments.

A rail system, including a left rail and a right rail, provides a retaining and guiding mechanism for supporting the flexible solar panel 106 during movement between stored and deployed positions. In one embodiment, the left rail and the right rail are positioned along opposing side portions of the vehicle roof area and are arranged to engage corresponding side portions of the flexible solar panel 106. The rail system cooperates with the vehicle roof structure to retain the flexible solar panel 106 in a fixed lateral position during deployment and retraction, thereby reducing unintended side-to-side displacement as the flexible solar panel 106 moves in a longitudinal direction along the vehicle body.

In certain embodiments, the rail system supports edge portions of the flexible solar panel 106 while maintaining the flexible solar panel 106 in an elevated relation relative to the roof surface. Such positioning may reduce direct contact between the flexible solar panel 106 and the roof during movement. The rail system may further define a controlled travel path for the flexible solar panel 106 so that deployment and retraction occur in a guided and repeatable manner.

In operation, the left rail and the right rail may function together with adjacent guide structures, cable members, and deployment assemblies to maintain alignment of the flexible solar panel 106 as the flexible solar panel 106 is extended over or withdrawn from the upper exterior surfaces of the vehicle. The rail system therefore assists in supporting, positioning, and directing movement of the flexible solar panel 106 during use. The rail system is associated with guides that extend along the vehicle body. The guides constrain the movement of the flexible solar panel 106 and the cable wires, thereby guiding the flexible solar panel 106 along a predetermined path during deployment and retraction. The flexible solar panel 106 includes a flexible negative conducting connector and a flexible positive conducting connector. When the flexible solar panel 106 is deployed, the conducting connectors are placed in electrical communication with the vehicle charging circuitry, allowing electrical energy generated by the flexible solar panel 106 to be transmitted for recharging vehicle batteries.

A control board monitors charge levels of the EV 102 battery and communicates with vehicle control electronics to regulate power delivery from the flexible solar panel 106. In one embodiment, the control board is operatively coupled to one or more components of the charging system and receives information associated with battery condition, available electrical energy generated by the flexible solar panel 106, and operating status of the vehicle. Based on such information, the control board may control, permit, limit, interrupt, or otherwise regulate delivery of electrical power from the flexible solar panel 106 to one or more vehicle batteries or related electrical systems.

In certain embodiments, the control board communicates with vehicle control electronics to coordinate charging activity with vehicle operating states, including parked, inactive, standby, or active conditions. The control board may further coordinate deployment or retraction of the flexible solar panel 106 with charging operations, battery charge level conditions, or user commands. In operation, the control board may assist in managing electrical power flow so that energy generated by the flexible solar panel 106 is delivered in a controlled manner consistent with battery charging requirements and vehicle operating conditions.

In various embodiments, the flexible solar panel may be selectively deployable to cover the entire upper exterior length of the vehicle body or less than the entire upper exterior length of the vehicle body. The flexible solar panel may be configured to extend over all or only part of the hood, windshield, roof, trunk, hatch, rear deck, or other exterior vehicle surfaces, depending on vehicle geometry, sunlight conditions, user selection, available stored panel length, or system programming. In certain embodiments, the system may stop deployment at one or more intermediate positions such that the flexible solar panel covers only a partial area of the vehicle rather than a fully deployed position extending over substantially the entire vehicle.

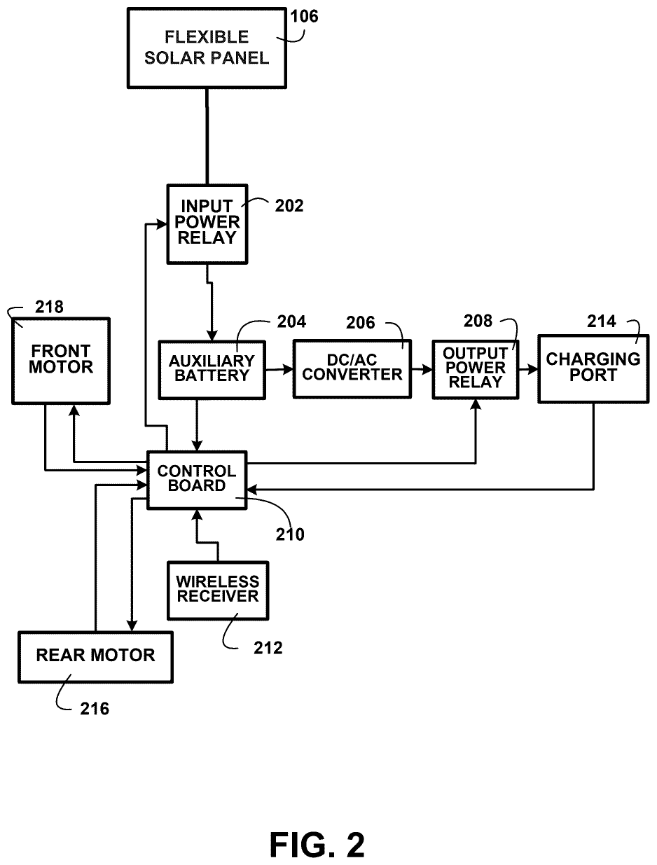

FIG. 2 shows a block diagram flowchart of an example of a flexible solar panel recharging system of one embodiment. FIG. 2 shows in one embodiment a flexible solar panel recharging system including the flexible solar panel 106, input power relay 202, auxiliary battery 204, DC/AC converter 206, output power relay 208, control board 218, wireless receiver 220, and EV charging port 214.

In operation, electrical power generated by the flexible solar panel 106 is supplied to the input power relay 202. The electrical power generated is processed through a pathway of subsystems configured to prepare the generated electrical power for recharging EV batteries, including the input power relay 202, auxiliary battery 204, DC/AC converter 206, and output power relay 208. The input power relay 202 is electrically connected to the auxiliary battery 204 and configured to accumulate electrical charge from the flexible solar panel 106. The auxiliary battery 204 is electrically coupled to the DC/AC converter 206 that converts DC electrical power to AC electrical power. Electrical power output from the DC/AC converter 206 is controlled by the output power relay 208 to the EV charging port 214, with the system operation managed by the control board 218. The wireless receiver 220 is operatively connected to the control board 218 to receive wireless commands for operation of the recharging system.

In certain embodiments, the flexible solar panel 106 operates as a primary energy generation component configured to convert sunlight into electrical energy. The flexible solar panel 106 supplies electrical power to the input power relay 202, which functions as an initial control point for directing electrical energy within the system. In one embodiment, the input power relay 202 selectively permits or restricts the flow of electrical energy based on signals received from the control board 218.

The input power relay 202 is electrically connected to the auxiliary battery 204. In certain embodiments, the auxiliary battery 204 serves as an intermediate energy storage device configured to accumulate electrical energy generated by the flexible solar panel 106. The auxiliary battery 204 may store electrical energy during periods of sunlight exposure and provide stored energy for subsequent delivery to downstream components.

In one embodiment, the auxiliary battery 204 is coupled to the DC/AC converter 206. The DC/AC converter 206 is configured to convert direct current electrical power received from the auxiliary battery 204 into alternating current electrical power. In certain embodiments, the DC/AC converter 206 may operate continuously or intermittently depending on system conditions, and may include internal circuitry for regulating voltage and output characteristics.

The output of the DC/AC converter 206 is controlled by the output power relay 208. In certain embodiments, the output power relay 208 regulates the delivery of electrical power to the EV charging port 214. The output power relay 208 may open or close electrical pathways in response to signals from the control board 218, thereby controlling when electrical energy is supplied to the EV charging port 214.

The EV charging port 214 is configured to receive electrical power from the output power relay 208 and deliver electrical energy to one or more vehicle batteries. In certain embodiments, the EV charging port 214 interfaces with existing vehicle charging systems and may operate in coordination with vehicle charging protocols.

The control board 218 is operatively connected to the input power relay 202, auxiliary battery 204, DC/AC converter 206, output power relay 208, and wireless receiver 220. In one embodiment, the control board 218 monitors system parameters including electrical output from the flexible solar panel 106, charge level of the auxiliary battery 204, and operational status of the relays 210 and 216. In certain embodiments, the control board 218 regulates the flow of electrical energy through the system by issuing control signals to the input power relay 202 and output power relay 208. The control board 218 may determine when to store electrical energy in the auxiliary battery 204 and when to supply electrical energy to the charging port 2212 of the EV 102.

The wireless receiver 220 is connected to the control board 218 and is configured to receive wireless commands. In certain embodiments, the wireless receiver 220 receives signals from a user device or external system, and the control board 218 responds by adjusting operation of the flexible solar panel 106 recharging system. The wireless receiver 220 may operate using various wireless communication methods.

In one embodiment, the system operates by receiving electrical energy from the flexible solar panel 106, directing the electrical energy through the input power relay 202 to the auxiliary battery 204, converting electrical energy through the DC/AC converter 206, and supplying electrical energy through the output power relay 208 to the charging port 222. The control board 218 coordinates each stage of this process based on system conditions.

In certain embodiments, the system may operate in multiple modes, including a charging mode in which electrical energy is supplied to the EV charging port 214, and a storage mode in which electrical energy is accumulated in the auxiliary battery 204. The control board 218 may switch between modes based on available solar energy, battery charge levels, or received commands through the wireless receiver 220.

In operation, FIG. 2 illustrates a coordinated electrical system in which energy generated by the flexible solar panel 106 is managed, stored, converted, and delivered to the EV charging port 214 under control of the control board 218, with wireless communication provided through the wireless receiver 220 to enable user interaction and system control.

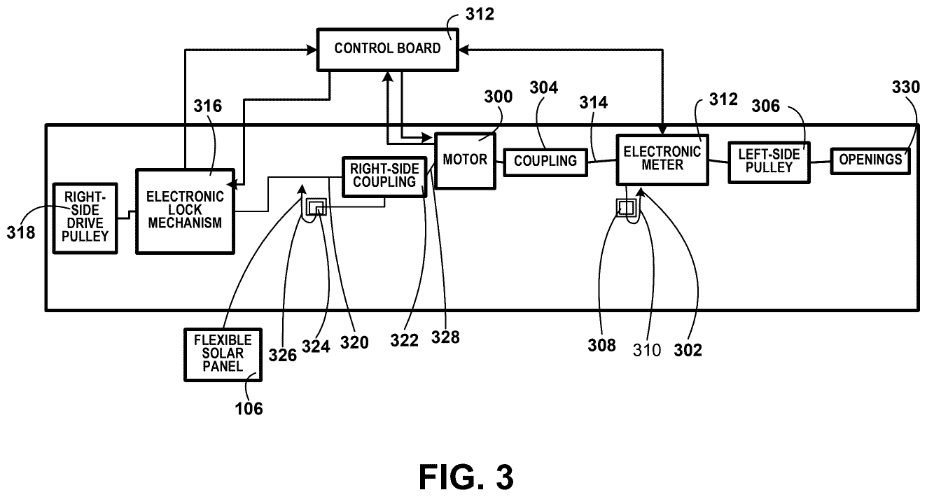

FIG. 3 shows a block diagram of an exploded view inside the pulling mechanism box under the front part of the EV of one embodiment. FIG. 3 illustrates an internal view of a pulling mechanism assembly positioned under a front portion of the electrified vehicle. The assembly controls the deployment and retraction of the flexible solar panel 106 of FIG. 1. A motor 300 is connected through a left-side shaft 302 and coupling 304 to a left-side pulley 306. A left-side external roller 308 guides a left-side cable wire 310 to the left-side rail, elevating the left side of the solar panel 106 of FIG. 1.

An electronic meter 312 counts rotational turns of the pulley system and communicates with the control board 218 of FIG. 2 through a wire 314. An electronic lock mechanism 316 remains closed when not operating and opens by the control board 218 of FIG. 2 during deployment or retraction of the flexible solar panel 106 of FIG. 1. FIG. 3 shows a right-side drive pulley 318, right-side shaft 320, and right-side coupling 304, right-side external roller 324, guide a right-side cable wire 326, with components enclosed inside the box 328. Openings 330 allow manual operation.

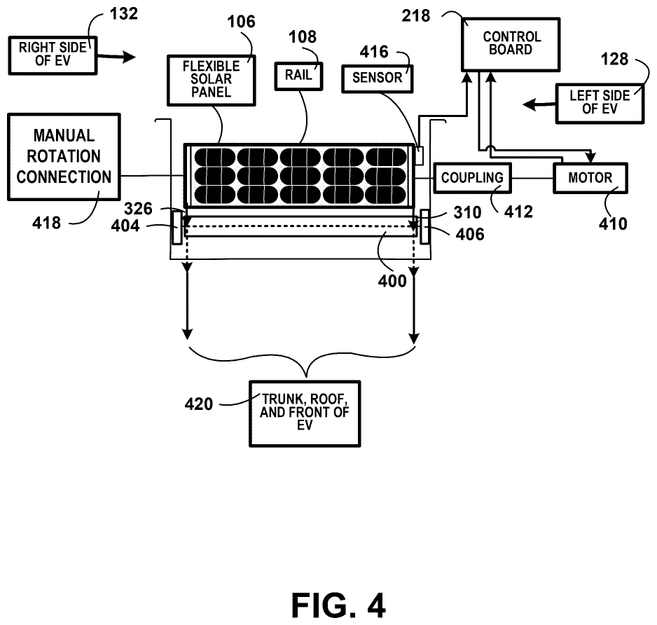

FIG. 4 shows, for illustrative purposes only, an exploded view inside of the rear box under the rear body part of an EV of one embodiment. The rear box assembly of FIG. 4 is positioned under a rear body portion of the electrified vehicle for winding and unwinding the flexible solar panel 106 to trunk, roof, and front of EV 420. The flexible solar panel 106 unwinds from the drum 400 and moves along the freely rotating drum 402. The limiters from the right side 404, and 406 from the left side guide the flexible solar panel 106 to outside of the box frame 408. With the help of the right-side cable wire 326 and left side cable wire 328, the flexible solar panel 106 is pulled further to cover the trunk, roof, and front of EV 102 of FIG. 1

A motor 410 drives a drum 400 through a coupling 412. The flexible solar panel 106 unwinds from the drum 400 and moves along a freely rotating drum 402. Limiters 404 and 406 guide the flexible solar panel 106 outward from the box frame 408.. With the help of the right-side cable wire 326 and left side cable wire 328, the flexible solar panel 106 is pulled further to cover the trunk, roof, and front of EV 102 of FIG. 1. A sensor 416 measures rotational turns of the drum 400, and sends a signal to control board 218 of FIG. 2 which stops the motor 410 at predetermined positions. A box frame 408 houses the components, and a manual rotation connection 418 allows manual operation.

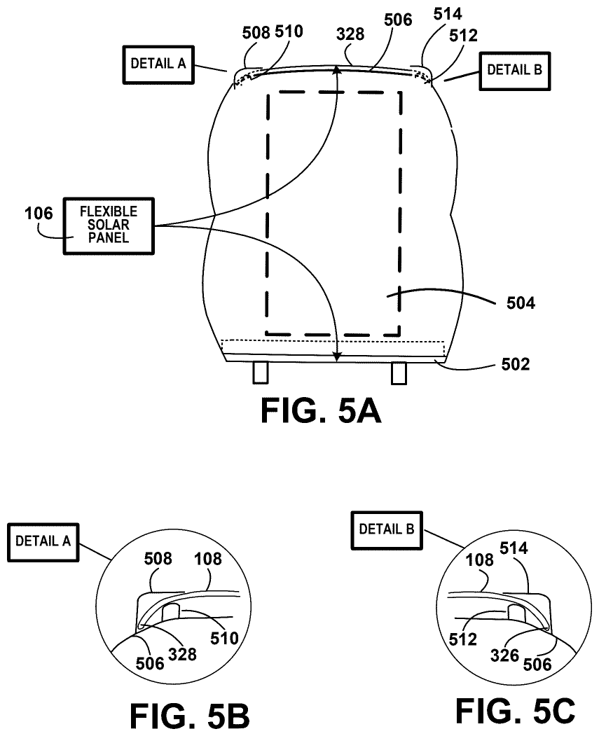

FIG. 5A shows an illustration of a rear view of an EV of one embodiment. FIG. 5A illustrates a rear view of the electrified vehicle showing a box 502 positioned under the vehicle body, a trunk 504, and a roof 506. The flexible solar panel 106 is guided by a left-side guide 508 and left-side rail 510, and by a right-side guide 514 and right-side rail 512.

A rear view of the electrified vehicle (EV 102) showing the spatial arrangement and cooperative relationship between the box 502, trunk 504, roof 506, flexible solar panel 106, left-side guide 508, left-side rail 510, right-side rail 512, and right-side guide 514.

In certain embodiments, the box 502 positioned under the vehicle body houses internal components associated with storage, deployment, and retraction of the flexible solar panel 106, including but not limited to winding structures, protective enclosures, and structural supports configured to maintain alignment of the flexible solar panel 106 during operation. The box 502 may be formed from metal, composite, or reinforced polymer materials configured to withstand environmental exposure, vibration, and mechanical loads encountered during vehicle operation.

In one embodiment, the trunk 504 represents a rear upper body portion of the EV 102 and serves as a transitional surface over which the flexible solar panel 106 travels during deployment. The trunk 504 may have a curved or planar geometry, and in certain embodiments includes surface coatings, paint layers, or protective finishes configured to resist wear in proximity to the movement path of the flexible solar panel 106.

The roof 506 extends forward from the trunk 504 and defines a primary upper surface over which the flexible solar panel 106 is deployed. In certain embodiments, the roof 506 may include a contoured geometry, and the flexible solar panel 106 is configured to travel above the roof 506 without direct contact, as maintained by the left-side rail 510 and right-side rail 512.

The flexible solar panel 106 is shown centrally positioned and extending longitudinally along the vehicle. In certain embodiments, the flexible solar panel 106 comprises a plurality of interconnected photovoltaic sections forming a continuous or semi-continuous energy-generating surface. The flexible solar panel 106 may include flexible substrates, encapsulated photovoltaic cells, and protective outer layers configured to allow bending and conforming movement while maintaining electrical continuity.

The left-side guide 508 and right-side guide 514 extend along opposing sides of the roof 506 and define constrained pathways for the flexible solar panel 106. In certain embodiments, the guides 508, 514 partially cover edge portions of the flexible solar panel 106 and prevent lateral displacement during deployment and retraction. The guides 508, 514 may be formed from metal, composite, or durable plastic materials and may include low-friction inner surfaces to facilitate smooth movement.

The left-side rail 510 and right-side rail 512 roof are positioned beneath corresponding edge portions of the flexible solar panel 106 and function to elevate the flexible solar panel 106 above the roof 506. In one embodiment, the rails 510, 512 provide a consistent spacing between the flexible solar panel 106 and the roof 506 along the entire deployment path. In certain embodiments, the rails 510, 512 may have a rounded, flat, or channel-shaped cross-section and may be constructed from metal or durable plastic materials configured for structural rigidity and wear resistance.

In operation, the flexible solar panel 106 is guided between the guides 508, 514 and supported by the rails 510, 512 such that the flexible solar panel 106 travels along a defined path from the rear portion of the EV 102 toward the front while remaining elevated above the roof 506, thereby reducing friction and minimizing mechanical interaction with vehicle surfaces.

FIG. 5B shows an illustration of a left side of the guide, rail, solar panel, and roof of an EV of one embodiment. FIG. 5B illustrates a left side detail showing the flexible solar panel 106, roof 506, left-side guide 508, left-side rail 510, and a left side cable wire 328. FIG. 5B illustrates a left-side detail view showing the relationship between the flexible solar panel 106, roof 506, left-side guide 508, left-side rail 510, and left side cable wire 328.

In certain embodiments, the flexible solar panel 106 is positioned above the roof 506 and extends longitudinally along the left side of the EV 102. The flexible solar panel 106 may be constructed from layered flexible materials including photovoltaic cells embedded within a flexible substrate, with outer protective coatings configured to resist environmental exposure such as moisture, ultraviolet radiation, and temperature variation.

The left-side guide 508 is positioned above an edge portion of the flexible solar panel 106 and functions to constrain the movement of the flexible solar panel 106 along a predetermined path. In one embodiment, the left-side guide 508 forms a partially enclosed channel that retains the edge of the flexible solar panel 106 while allowing longitudinal sliding movement. In certain embodiments, the inner surface of the left-side guide 508 may include low-friction coatings or inserts to reduce resistance during deployment and retraction.

The left-side rail 510 is positioned below the flexible solar panel 106 and above the roof 506, providing an elevating support structure. In certain embodiments, the left-side rail 510 maintains a defined clearance between the flexible solar panel 106 and the roof 506, preventing direct contact. The left-side rail 510 may be formed from rigid materials such as metal or reinforced plastic and may include a smooth upper surface to facilitate sliding contact with the flexible solar panel 106.

The roof 506 is shown beneath the left-side rail 510 and forms the structural surface of the EV 102. In certain embodiments, the roof 506 may include curvature or contouring, and the left-side rail 510 compensates for such geometry by maintaining a consistent elevation of the flexible solar panel 106 above the roof 506.

The left side cable wire 328 is coupled to the flexible solar panel 106 and extends along the left side of the EV 102. In certain embodiments, the left side cable wire 328 is attached to an edge portion of the flexible solar panel 106 and is configured to transmit pulling forces during deployment and retraction. The left side cable wire 328 may be formed from metal strands, braided cable, or high-strength synthetic material, and may include protective coatings to reduce wear and environmental degradation.

In operation, the left side cable wire 328 pulls the flexible solar panel 106 along the left-side rail 510 while the left-side guide 508 constrains lateral movement, thereby ensuring that the flexible solar panel 106 travels in a controlled and aligned manner relative to the roof 506.

FIG. 5C shows an illustration of a right side of the guide, rail, solar panel, and roof of an EV of one embodiment. FIG. 5C illustrates a right-side detail showing the flexible solar panel 106, roof 506, right-side rail 512, right-side guide 514, and right-side cable wire 326. FIG. 5C illustrates a right-side detail view showing the flexible solar panel 106, roof 506, right-side rail 512, right-side guide 514, and right-side cable wire 326.

In certain embodiments, the flexible solar panel 106 is supported along its right edge by the right-side rail 512 and is constrained in position by the right-side guide 514. The flexible solar panel 106 may include flexible photovoltaic materials configured to generate electrical energy when exposed to sunlight while maintaining the ability to bend and conform during deployment and retraction.

The right-side guide 514 is positioned above the flexible solar panel 106 and functions to restrict lateral displacement of the flexible solar panel 106. In one embodiment, the right-side guide 514 forms a retaining structure that partially encloses the edge of the flexible solar panel 106, maintaining alignment with the right-side rail 512. In certain embodiments, the right-side guide 514 may include structural reinforcements and wear-resistant surfaces to accommodate repeated movement cycles.

The right-side rail 512 is positioned between the flexible solar panel 106 and the roof 506 and serves to elevate the flexible solar panel 106 above the roof surface. In certain embodiments, the right-side rail 512 maintains a consistent separation distance, thereby preventing direct contact and reducing friction. The right-side rail 512 may be constructed from metal or durable plastic materials and may be configured with a geometry that supports smooth longitudinal movement of the flexible solar panel 106.

The roof 506 is positioned beneath the right-side rail 512 and provides the structural upper surface of the EV 102. In certain embodiments, the roof 506 may include coatings or finishes designed to resist environmental exposure and may be shaped to complement aerodynamic characteristics of the vehicle.

The right-side cable wire 326 is coupled to the flexible solar panel 106 and extends along the right side of the EV 102. In certain embodiments, the right-side cable wire 326 is configured to apply tension to the flexible solar panel 106 during deployment and retraction, working in coordination with the left side cable wire 328 to maintain balanced movement. The right-side cable wire 326 may be formed from high-strength materials and may include protective sheathing or coatings.

In operation, the right-side cable wire 326 pulls the flexible solar panel 106 along the right-side rail 512 while the right-side guide 514 constrains movement, thereby maintaining alignment and ensuring coordinated deployment with the left-side components.

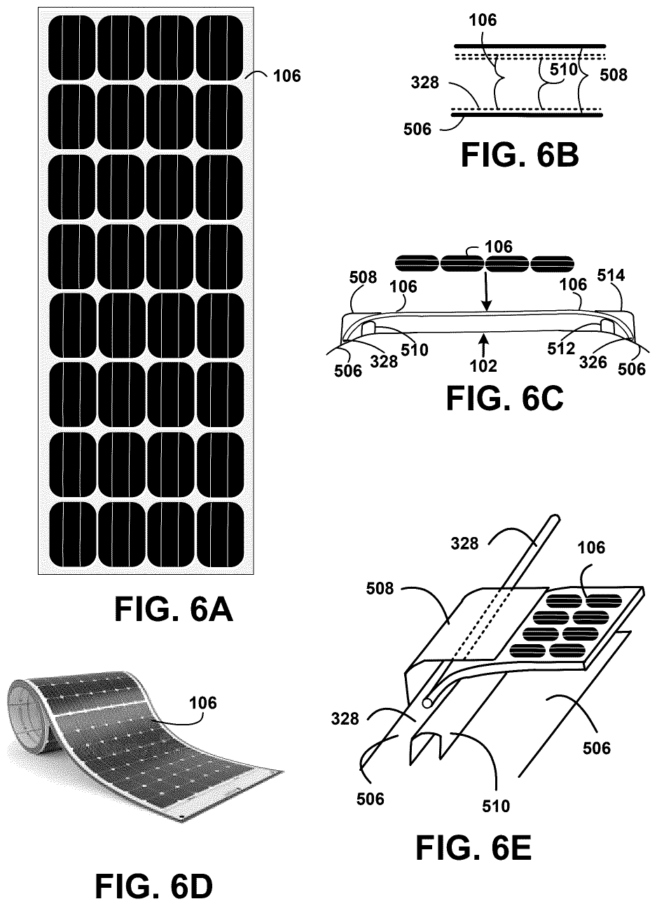

FIG. 6A shows an illustration of the top view of a flexible solar panel 106 of one embodiment. In certain embodiments, the flexible solar panel 106 is formed as an elongated, continuous structure extending in a longitudinal direction and configured to cover a substantial portion of the EV 102 roof area when deployed. The flexible solar panel 106 includes a plurality of solar cell regions arranged in a repeating pattern, each region configured to convert sunlight into electrical energy. In one embodiment, the solar cell regions are arranged in rows and columns along the length of the flexible solar panel 106.

In certain embodiments, the flexible solar panel 106 is constructed using flexible photovoltaic materials that allow bending without compromising electrical continuity. The flexible solar panel 106 may include a layered construction comprising a flexible substrate, photovoltaic cell layer, conductive interconnects, and an outer protective layer. The outer protective layer may be transparent or semi-transparent and configured to resist environmental exposure including ultraviolet radiation, moisture, debris, and temperature variation.

In one embodiment, the flexible solar panel 106 exhibits a degree of flexibility sufficient to allow the flexible solar panel 106 to be wound onto a drum and unwound during deployment and retraction. In certain embodiments, the flexible solar panel 106 is capable of conforming to curved surfaces of the EV 102 while maintaining structural integrity.

In certain embodiments, electrical interconnections within the flexible solar panel 106 distribute generated electrical energy along the length of the flexible solar panel 106 to conducting connectors positioned at one or more ends or edges. The flexible solar panel 106 may include embedded conductive traces configured to transmit electrical energy during both stationary and moving states of the flexible solar panel 106.

FIG. 6B shows an illustration of a detail, a left side cross-section view of a flexible solar panel, guide, rail, and EV's roof of one embodiment. FIG. 6B illustrates a left side view showing the flexible solar panel 106 positioned above the roof 506 and guided by the left-side guide 508 and left-side rail 510, with a left side cable wire 328. FIG. 6B illustrates a left side view showing the flexible solar panel 106 positioned above the roof 506 and guided by the left-side guide 508 and left-side rail 510, with a left side cable wire 328.

In certain embodiments, the flexible solar panel 106 is positioned above the roof 506 and supported by the left-side rail 510 such that a spacing is maintained between the flexible solar panel 106 and the roof 506. This spacing reduces friction and prevents direct mechanical contact between the flexible solar panel 106 and the roof 506 during deployment and retraction.

The left-side rail 510 provides an elevating structure beneath the flexible solar panel 106. In one embodiment, the left-side rail 510 extends longitudinally along the roof 506 and maintains a consistent height relative to the roof 506. In certain embodiments, the left-side rail 510 may include a smooth upper surface to facilitate sliding movement of the flexible solar panel 106.

The left-side guide 508 is positioned above the flexible solar panel 106 and forms a retaining structure that constrains lateral movement. In certain embodiments, the left-side guide 508 partially encloses an edge portion of the flexible solar panel 106, maintaining alignment with the left-side rail 510 while permitting longitudinal motion.

The left side cable wire 328 is coupled to the flexible solar panel 106 and extends along the left side. In one embodiment, the left side cable wire 328 applies pulling force to move the flexible solar panel 106 along the left-side rail 510. In certain embodiments, the left side cable wire 328 is maintained under tension to ensure consistent alignment and controlled movement.

In operation, the flexible solar panel 106 is guided between the left-side guide 508 and the left-side rail 510 while being pulled by the left side cable wire 328, thereby ensuring smooth, aligned movement along the roof 506.

FIG. 6C shows an illustration of the view of the top part of FIG. 5A with the left and right parts for a flexible solar panel of one embodiment. FIG. 6C illustrates a top portion view showing the EV 102 having the flexible solar panel 106 elevated above the EV's roof 506. On the left side of the EV, the left side guide 508, left side rail 510, on the right side of the EV, the right-side rail 512, and right-side guide 514. The details further show a left-side cable wire 310 attached to the elevated flexible solar panel 106 left side and a right-side cable wire 326 attached to the elevated flexible solar panel 106 right side to create tension and maintain support of the elevated flexible solar panel 106 during deployment and retraction along the guides and rails.

FIG. 6C illustrates a top portion view showing the EV 102 having the flexible solar panel 106 elevated above the EV's roof 506, with the left side guide 508, left side rail 510, right-side rail 512, and right-side guide 514. In certain embodiments, the flexible solar panel 106 is centrally positioned above the roof 506 and spans across the width of the EV 102 while being supported along its edges by the left side rail 510 and right-side rail 512. The flexible solar panel 106 is maintained in an elevated position above the roof 506 by the rails 510, 512, thereby preventing direct contact with the roof 506.

The left side guide 508 and right-side guide 514 extend along opposing sides and function to constrain lateral movement of the flexible solar panel 106. In certain embodiments, the guides 508, 514 form channel-like structures that retain the edges of the flexible solar panel 106 and maintain alignment during deployment and retraction.

The left-side cable wire 310 is attached to the left side of the flexible solar panel 106, and the right-side cable wire 326 is attached to the right side of the flexible solar panel 106. In certain embodiments, the cable wires 310, 326 apply balanced pulling forces to maintain tension across the flexible solar panel 106.

In one embodiment, the coordinated action of the left-side cable wire 310 and right-side cable wire 326 maintains the flexible solar panel 106 in a taut and stable configuration during movement. In certain embodiments, the tension applied by the cable wires 328, 326 prevents sagging or uneven displacement of the flexible solar panel 106. In operation, the flexible solar panel 106 is guided along both sides simultaneously, with the rails 510, 512 providing elevation and the guides 508, 514 providing lateral constraint, thereby ensuring uniform deployment across the roof 506.

FIG. 6D shows an illustration of a flexible solar panel in a rolled position of one embodiment. FIG. 6D illustrates the flexible solar panel 106 in a rolled position. In certain embodiments, the flexible solar panel 106 is configured to be wound into a compact rolled configuration for storage when not deployed. The rolled position allows the flexible solar panel 106 to be stored on a drum located within a rear-mounted or underbody assembly.

In one embodiment, the flexible solar panel 106 is wound around a cylindrical structure, forming multiple layers of the flexible solar panel 106. In certain embodiments, the flexible solar panel 106 maintains its structural and electrical integrity while in the rolled configuration.

The flexible solar panel 106 may include flexible materials and layered construction that allow repeated bending and rolling without degradation of performance. In certain embodiments, the flexible solar panel 106 includes reinforcement layers or embedded structures that distribute stress during rolling and unrolling.

In one embodiment, the rolled configuration allows the flexible solar panel 106 to be deployed and retracted efficiently using motor-driven mechanisms. In certain embodiments, the rolling and unrolling motion is coordinated with cable wires to ensure controlled movement and alignment during transition between stored and deployed states.

FIG. 6E shows an illustration of a more detailed view of section A of FIG. 5A of one embodiment. FIG. 6E shows the flexible solar panel 106 elevated above the EV's roof 506. The left-side guide 508, left-side rail 510, are shown in a prospective view to demonstrate the guide role and rail elevation system having the edge of the solar panel 106 under the guide 508 and over the rail 510 and the roof 506. Cable wire 310 is attached to the edge of flexible solar panel 106.

FIG. 6E shows the flexible solar panel 106 elevated above the EV's roof 506, with the left-side guide 508, left-side rail 510, and cable wire 310. In certain embodiments, the flexible solar panel 106 is positioned such that an edge portion is retained beneath the left-side guide 508 and supported above the left-side rail 510. This configuration creates a guided pathway in which the flexible solar panel 106 is constrained from above by the left-side guide 508 and supported from below by the left-side rail 510. The left-side guide 508 may include a curved or angled geometry configured to direct the flexible solar panel 106 into a defined position relative to the left-side rail 510. In certain embodiments, the left-side guide 508 functions as both a retaining structure and a directional guide for the flexible solar panel 106.

The left-side rail 510 elevates the flexible solar panel 106 above the roof 506 and provides a sliding support surface. In certain embodiments, the left-side rail 510 maintains a consistent elevation even where the roof 506 includes curvature or contour. The cable wire 310 is attached to the flexible solar panel 106 and extends through the guided pathway formed by the left-side guide 508 and left-side rail 510. In one embodiment, the cable wire 310 transmits pulling force to move the flexible solar panel 106 along the guide and rail system. In operation, the flexible solar panel 106 travels along a defined channel formed between the left-side guide 508 and left-side rail 510, with the cable wire 310 maintaining tension and driving movement, thereby ensuring controlled deployment and retraction above the roof 506.

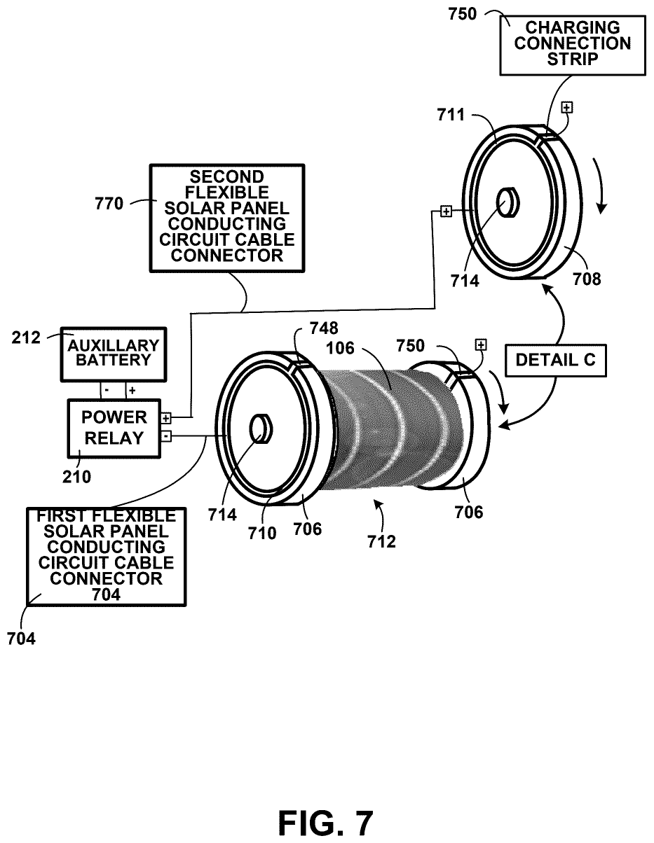

FIG. 7 shows an illustration of a solar panel drum charging circuit connections of one embodiment. FIG. 7 illustrates a solar panel drum charging circuit associated with the flexible solar panel 106. The flexible solar panel 106 is deployed and rewound on the drum 400 with charging connections 748 and 750 integrated into each side of the drum and right side 700, left side 710, embedded conductive strip 702 and 711 accordingly. The drum 400 is rotated on an axle 714 driven by a motor not shown.

An embedded contacting negative strip 702 is provided at one end of the drum with a flexible solar panel 106 and is electrically coupled to a negative conducting connector 702, and at the other end of the winding drum 400, coupled to a positive conducting connector 76, which is connected to an embedded contacting positive strip 711. A first flexible conducting connector 704 electrically connects the negative conducting connector 71 to a power relay 212, and a second flexible conducting connector 770 electrically connects the positive conducting connector 711 to the power relay 212.

The power relay 212 accumulates charge from the solar panel 106, which supplies electrical energy to an auxiliary battery 204. The auxiliary battery 204 supplies power to recharge the EV battery. The opposite ends of the drum 400 provide positive and negative electrical connections while the flexible solar panel 106 is deployed and unwound from the drum 400 over the EV roof. The rear drum guided pathways for the movement of the flexible solar panel 106 during deployment and retraction.

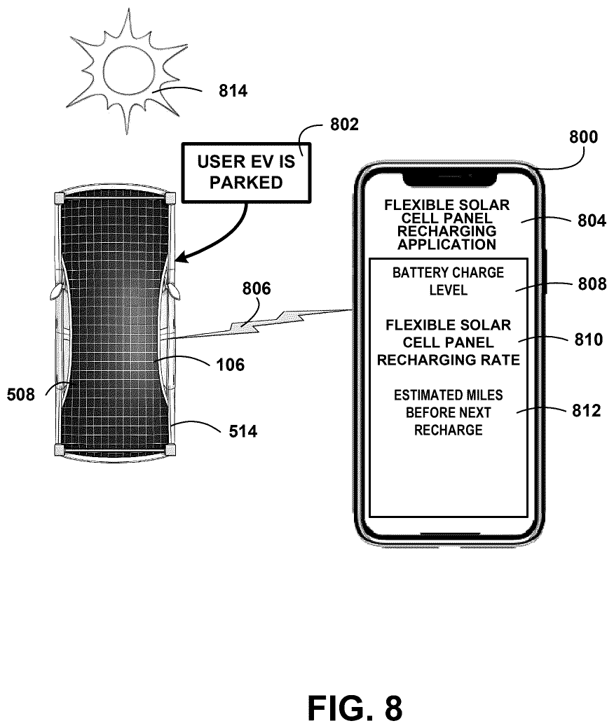

FIG. 8 shows an illustration of a user-parked EV with a deployed flexible solar panel to recharge the battery while parked of one embodiment. FIG. 8 illustrates a flexible solar panel recharging application 804 while a user's EV is parked 802. The flexible solar panel 106 is deployed and exposed to sunlight 824 for generating electrical energy. The solar panel 106 is deployed along the guides 508 and 514.

Charging information is transmitted 806 to a user device 800 executing the flexible solar panel recharging application 804. The flexible solar panel recharging application 804 displays a battery charge level 808, a recharging rate 820, and estimated miles before next recharge 822.

FIG. 8 illustrates a parked EV 802 with a deployed flexible solar panel 106 exposed to sunlight 824 for generating electrical energy, with charging information transmitted 806 to a user device 80 800 executing a flexible solar panel recharging application 804 displaying a battery charge level 808, a recharging rate 820, and estimated miles before next recharge 822.

In certain embodiments, the parked EV 802 is in an outdoor environment where the flexible solar panel 106 is exposed to sunlight 824 824 under varying environmental conditions. The sunlight 824 may include direct sunlight, indirect sunlight, or diffused light conditions, and the flexible solar panel 106 is configured to generate electrical energy under a range of light intensities. In one embodiment, the flexible solar panel 106 operates during daylight hours, and in certain embodiments may continue to generate electrical energy under partially shaded or cloudy conditions.

The flexible solar panel 106 is shown in a deployed state over the exterior surface of the parked EV 802, and in certain embodiments is positioned along the guides 508 and 514 as previously described. The flexible solar panel 106 may cover substantially the entire upper portion of the parked EV 802, thereby maximizing exposure to sunlight 824. In certain embodiments, the flexible solar panel 106 maintains an elevated position above the vehicle surface to reduce heat transfer and mechanical interaction with the vehicle body.

In one embodiment, the flexible solar panel 106 generates electrical energy continuously while exposed to sunlight 824, and the generated electrical energy is transmitted through the recharging system to supply power to vehicle electrical systems and to recharge one or more batteries. In certain embodiments, the amount of generated electrical energy varies based on solar intensity, angle of incidence of sunlight 824, environmental temperature, and duration of exposure.

The charging information is transmitted 806 from the parked EV 802 to the user device 800. In certain embodiments, the transmission 806 may occur through wireless communication protocols including but not limited to radio frequency communication, cellular communication, or short-range wireless communication. The transmission 806 may occur continuously, periodically, or in response to system events.

The user device 800 executes a flexible solar panel recharging application 804 configured to display system information to a user. In one embodiment, the battery charge level 808 represents a current state of charge of a vehicle battery system. In certain embodiments, the battery charge level 808 may be displayed as a percentage, graphical indicator, or numerical value.

The recharging rate 820 represents a rate at which electrical energy is being generated by the flexible solar panel 106 and supplied to the vehicle battery system. In certain embodiments, the recharging rate 820 may be expressed in units of power or energy per unit time and may vary dynamically based on sunlight 824 conditions and system efficiency.

The estimated miles before next recharge 822 represents an estimated driving range associated with the current battery charge level 808 and recharging rate 820. In certain embodiments, the estimated miles before next recharge 822 is calculated using vehicle efficiency parameters, historical usage data, or real-time system inputs.

In one embodiment, the flexible solar panel recharging application 804 provides real-time updates to the user device 800, allowing a user to monitor charging performance while EV 802 is parked. In certain embodiments, the flexible solar panel recharging application 804 may include additional display features, alerts, or notifications associated with system status, although the displayed elements remain the battery charge level 808, recharging rate 820, and estimated miles before next recharge 822 822.

In certain embodiments, deployment of the flexible solar panel 106 may occur automatically when EV 802 is parked, and in other embodiments deployment may be initiated manually by a user through the user device 80 or through vehicle controls. Retraction of the flexible solar panel 106 may occur when EV 802 is no longer parked or in response to user input or environmental conditions.

In operation, FIG. 8 illustrates an integrated system in which the flexible solar panel 106 generates electrical energy from sunlight 824 while EV 802 is parked, and system performance data is transmitted 806 806 to the user device 800 for display through the flexible solar panel recharging application 804, thereby enabling user awareness and monitoring of solar-based recharging.

The foregoing description sets forth various principles, embodiments, configurations, and modes of operation of the present invention. It is to be understood, however, that the invention is not limited to the particular embodiments expressly described herein. Rather, those embodiments are provided to illustrate aspects of the invention and to enable a person of ordinary skill in the art to make and use the disclosed subject matter. The disclosed embodiments therefore should be regarded as illustrative and not restrictive. It should further be appreciated that modifications, substitutions, additions, omissions, re-orderings, and alternative arrangements may be made to the structures, components, materials, steps, and functionalities described herein without departing from the spirit and scope of the invention. In addition, features described in connection with one embodiment may be combined with features of another embodiment, unless expressly stated otherwise or unless such combination would be inoperable. Thus, workers skilled in the art, having the benefit of the present disclosure, will recognize that many variations are possible while still falling within the scope of the invention. Accordingly, the scope of protection is not intended to be limited by the foregoing description, but instead is defined by the appended claims and their equivalents, including all changes and modifications that come within the meaning and range of equivalency of the claims.

What is claimed is:

1. A battery charging system for a vehicle having a vehicle body, a roof, and upper exterior surfaces, the battery charging system comprising:
a flexible solar panel movable between a stored position and a deployed position above at least a portion of the roof and upper exterior surfaces;
a guide system configured to direct movement of the flexible solar panel during deployment and retraction;
a support system including at least one rail configured to maintain at least a portion of the flexible solar panel in spaced relation above the roof and upper exterior surfaces during deployment;
a first deployment assembly configured to store or release the flexible solar panel;
a second deployment assembly operatively coupled to the flexible solar panel and configured to move the flexible solar panel between the stored position and the deployed position; and
wherein the flexible solar panel is configured to generate electrical energy for charging at least one battery of the vehicle when in the deployed position.

2. The battery charging system of claim 1, wherein the first deployment assembly comprises a motor-driven winding drum configured to store the flexible solar panel in a rolled configuration and including rotating electrical contacts configured to transmit electrical energy generated by the flexible solar panel while the flexible solar panel moves between the stored position and the deployed position.

3. The battery charging system of claim 1, wherein the second deployment assembly comprises a pulley system including at least one drive pulley and at least one guide roller configured to maintain tension and lateral alignment of the flexible solar panel during deployment and retraction.

4. The battery charging system of claim 1, wherein the flexible solar panel is operatively coupled to the second deployment assembly by at least two deployment cable members disposed along opposing side edge portions of the flexible solar panel.

5. The battery charging system of claim 1, wherein the guide system and the support system are configured to maintain the flexible solar panel in spaced relation above the roof and upper exterior surfaces along substantially an entire deployed length of the flexible solar panel.

6. The battery charging system of claim 1, wherein, in the deployed position, the flexible solar panel extends over substantially an entire longitudinal length of the vehicle body.

7. The battery charging system of claim 1, wherein movement of the flexible solar panel from the stored position to the deployed position is initiated automatically in response to the vehicle being in a parked condition and a detected sunlight condition satisfying a predetermined threshold.

8. A battery charging system for a vehicle having a vehicle body, a roof, and upper exterior surfaces, the battery charging system comprising:
a flexible solar panel movable between a stored position and a deployed position above at least a portion of the roof and upper exterior surfaces;
a guide system configured to direct movement of the flexible solar panel during deployment and retraction;
a support system including at least one rail configured to maintain at least a portion of the flexible solar panel in spaced relation above the roof and upper exterior surfaces during deployment;
a first deployment assembly configured to store the flexible solar panel in the stored position and to selectively release the flexible solar panel for movement from the stored position toward the deployed position;
a second deployment assembly operatively coupled to the flexible solar panel and configured to move the flexible solar panel between the stored position and the deployed position; and
wherein the flexible solar panel is configured to generate electrical energy for charging at least one battery of the vehicle when in the deployed position.

9. The battery charging system of claim 8, wherein the first deployment assembly comprises a motor-driven winding drum configured to store the flexible solar panel in a rolled configuration and including rotating electrical contacts configured to transmit electrical energy generated by the flexible solar panel while the flexible solar panel moves between the stored position and the deployed position.

10. The battery charging system of claim 8, wherein the second deployment assembly comprises a pulley system including at least one drive pulley and at least one guide roller configured to maintain tension and lateral alignment of the flexible solar panel during deployment and retraction.

11. The battery charging system of claim 8, wherein the flexible solar panel is operatively coupled to the second deployment assembly by at least two deployment cable members disposed along opposing side edge portions of the flexible solar panel.

12. The battery charging system of claim 8, wherein the guide system and the support system are configured to maintain the flexible solar panel in spaced relation above the roof and upper exterior surfaces along substantially an entire deployed length of the flexible solar panel.

13. The battery charging system of claim 8, wherein, in the deployed position, the flexible solar panel extends over substantially an entire longitudinal length of the vehicle body.

14. The battery charging system of claim 8, wherein movement of the flexible solar panel from the stored position to the deployed position is initiated automatically in response to the vehicle being in a parked condition and a detected sunlight condition satisfying a predetermined threshold.

15. A battery charging system for a vehicle having a vehicle body, a roof, and upper exterior surfaces, the battery charging system comprising:
a flexible solar panel movable between a stored position and a deployed position above at least a portion of the roof and upper exterior surfaces;
a guide system configured to direct movement of the flexible solar panel during deployment and retraction;
a support system including at least one rail configured to maintain at least a portion of the flexible solar panel in spaced relation above the roof and upper exterior surfaces during deployment;
a first deployment assembly configured to store the flexible solar panel in the stored position and to selectively release the flexible solar panel for movement from the stored position toward the deployed position;
a second deployment assembly operatively coupled to the flexible solar panel and configured to drive, pull, guide, or otherwise move the flexible solar panel between the stored position and the deployed position during deployment and retraction operations; and
wherein, when positioned in the deployed position, the flexible solar panel is exposed to ambient light and is configured to generate electrical energy for charging, supplementing charging of, or maintaining charge of at least one battery of the vehicle.

16. The battery charging system of claim 15, wherein the second deployment assembly comprises a pulley system including at least one drive pulley and at least one guide roller configured to maintain tension and lateral alignment of the flexible solar panel during deployment and retraction.

17. The battery charging system of claim 15, wherein the flexible solar panel is operatively coupled to the second deployment assembly by at least two deployment cable members disposed along opposing side edge portions of the flexible solar panel.

18. The battery charging system of claim 15, wherein the guide system and the support system are configured to maintain the flexible solar panel in spaced relation above the roof and upper exterior surfaces along substantially an entire deployed length of the flexible solar panel.

19. The battery charging system of claim 15, wherein, in the deployed position, the flexible solar panel extends over substantially an entire longitudinal length of the vehicle body.

20. The battery charging system of claim 15, wherein movement of the flexible solar panel from the stored position to the deployed position is initiated automatically in response to the vehicle being in a parked condition and a detected sunlight condition satisfying a predetermined threshold.
